(19) United States
(12) Patent Application Publication
(10) Pub. No.: US 2008/0233021 A1
(43) Pub. Date: Sep. 25, 2008

(54) Twin-tube type water-cooling ozone generation tube assembly

(76) Inventor: Huei-Tarng Liou, Taipei City (TW)

Correspondence Address: Ladas & Parry LLP, 26 West 61st Street, New York, NY, 10023, US

(21) Appl. No.: 11/726,574

(22) Filed: Mar. 22, 2007

(51) Int. Cl. B01J 19/08

(52) U.S. Cl. 422/186.19

(57) ABSTRACT

A water-cooling ozone generation tube assembly includes a twin-tube type ozone generation tube module and a tube holder. The twin-tube type ozone generation tube module contains an inner tube and an outer tube. The ozone generation tube assembly of the present invention is water cooled; both the inner tube and the outer tube of the tube module are cooled by water so as to improve the cooling effect and further increase the ozone generation throughput. The ozone generation tube assembly can be configured to include more than one ozone generation tube module when a large amount of ozone is to be produced.

### FIELD OF THE INVENTION

The invention relates to a twin-tube type, water-cooling ozone generation tube assembly. More particularly, the invention relates to an ozone generation tube assembly including multiple ozone generation tube modules, wherein each tube module has an inner tube and an outer tube, and both the inner and outer tubes are cooled by water.

### BACKGROUND OF THE INVENTION

Ozone is usually applied to treat the water to be used in semiconductor industries, aquatic product industries, swimming pools, households, etc. In a typical process of ozone production, oxygen-containing gas is guided through a high voltage discharge zone in an ozone generation tube, across which a high voltage is applied. The oxygen will be ionized while passing through the ozone generation tube.

U.S. Pat. No. 4,101,783 discloses similar features of producing ozone in an ozone generation tube. As shown in FIG. 1, the ozone generator comprises several twin-walled upright glass tubes 1. Each tube 1 has an inner wall 1a, an outer wall 1b, an inlet 5 which admits air (or another oxygen-containing gas) into an annular chamber 3 between the walls 1a, 1b, and an outlet 6 which serves to evacuate enriched gas from the chamber 3. A first electrode 12 overlies the median portion of the inner side of the inner wall 1a, and a second electrode 8 overlies the median portion of the outer side of the outer wall 1b opposite the electrode 12. When the generator is operated, a high voltage is applied across the electrodes 12, 8, which causes an electric arc between the electrodes and generates ozone.

In the discharge reaction, a large amount of heat energy is generated. The ozone generation tube, which provides the chamber for the discharge reaction to take place in, has to endure the heat thus generated. In many circumstances, the production rate of ozone should be large enough to meet the practical need. Thus, more heat would be generated in the ozone generation tube. The heat often causes the tube to rise to a very high temperature, which may damage the tube or reduce the lifespan of the tube. Heat reduction is thus a significant issue for an ozone generation system used for a higher rate of ozone generation.

Water cooling is usually used to reduce the heat produced in the ozone generation tube in the ozone generation industry. However, the state of the art only relates to cooling the outer tube of the ozone generator. It is known that the temperature in the inner tube is also very high in the discharge process. Accordingly, it is an object of the present invention to improve the cooling effect of the inner ozone generation tube by cooling it where temperature is high enough to damage the tube.

It is also an object of the present invention to provide means to produce a higher ozone generation rate having a sufficient cooling effect.

### SUMMARY OF THE INVENTION

The present invention provides a twin-tube ozone generation tube, where both the inner tube and the outer tube are water cooled to effectively reduce the heat generated therein.

To achieve the object of effectively cooling the ozone generation tube, the ozone generation system of the present invention further contains a tube holder, which not only holds the ozone generation tube in place but also provides a chamber so that cooling water may pass through and thereby carry away the heat transferred from the tube to the tube holder.

To achieve the object of providing a higher ozone production rate, the ozone generation tubes according to the present invention can be assembled together by stacking the tube holders in a desired manner.

The specific measures for achieving the objects of the present invention will become apparent to those skilled in the art by making reference to the drawings of the present invention and the following detailed descriptions of the preferred embodiment.

### BRIEF DESCRIPTION OF THE DRAWING

FIG. 1 is a perspective view of an ozone generation tube assembly of the present invention;

FIG. 2 is a cross-sectional view taken along line 2-2 in FIG. 3;

FIG. 3 is a cross-sectional view taken along line 3-3 in FIG. 2;

FIG. 4 shows the interior of the ozone generation tube assembly;

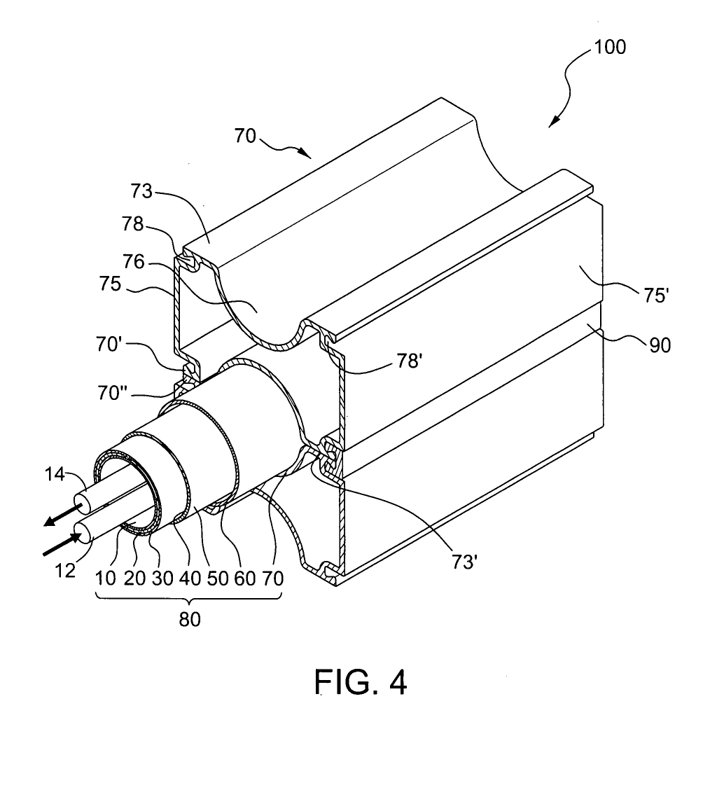

FIG. 5 shows the state in which the ozone generation tube assembly is constituted by multiple tube modules; and

FIG. 6 shows the end view of the ozone generation tube assembly not shown in FIG. 5.

### DETAILED DESCRIPTION OF THE INVENTION

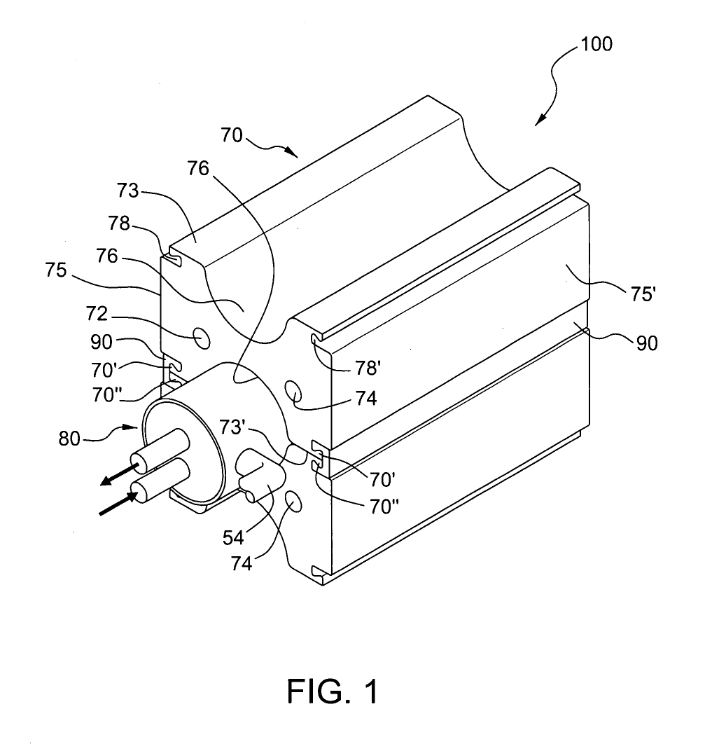

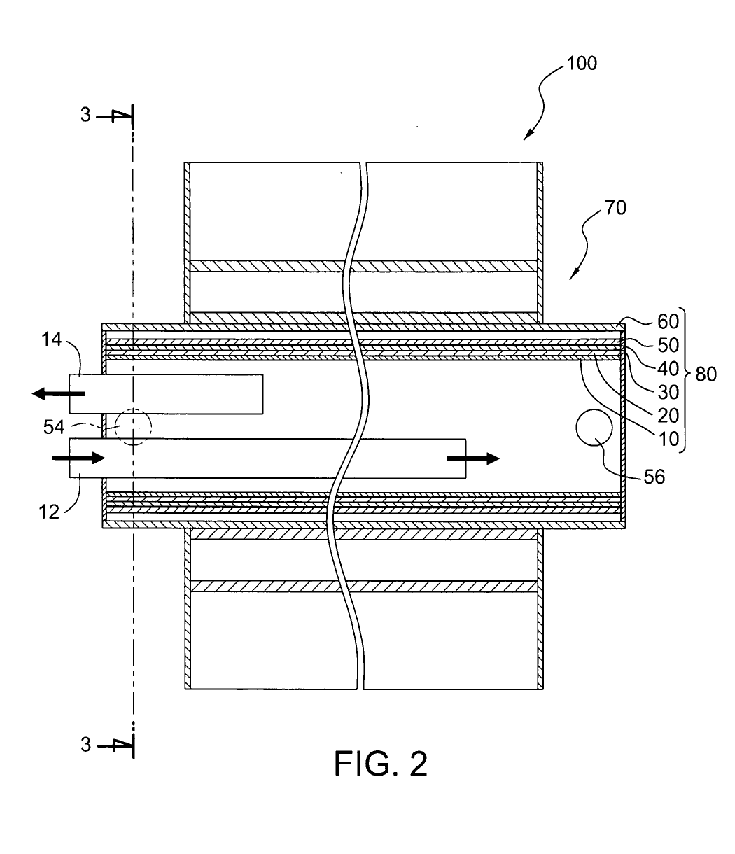

Referring to FIG. 1, the ozone generation tube assembly 100 comprises a twin-tube type ozone generation tube module 80 and a tube holder 70. The two ends of the tube assembly 100 are sealed as shown in FIG. 2.

The tube module 80 comprises an aluminum tube 10, a tubular electrode 30, an inner quartz tube 50, and an outer quartz tube 60. The aluminum tube 10, which is the innermost ring of the tube module 80, has a water inlet 12 and a water outlet 14. The aluminum tube 10 is enclosed in the tubular electrode 30 and an annular gap is formed between the aluminum tube 10 and the tubular electrode 30. The annular gap is filled with an insulation layer 20 so that the aluminum tube 10 and the tubular electrode 30 are kept electrically insulated from each other. The insulation layer 20 also serves to fix the aluminum tube 10 in the tubular electrode 30. The insulation layer 20 may be made of materials selected from rubber. The inner quartz tube 50 is arranged to enclose the tubular electrode 30 and the outer quartz tube 60 is arranged to enclose the inner quartz tube 50 so that an annular space 52 is formed. The annular space 52 is closed at both its ends by sealing the ends of the inner quartz tube 50 and the outer quartz tube 60. A gas inlet 54 is provided at one end of the outer quartz tube 60 and a gas outlet 56 is provided at the other end of the outer quartz tube 60.

A tube holder 70 is provided to enclose the tube module 80. The tube holder 70 has at least one water inlet 72 and at least one water outlet 74.

During operation, a high voltage of 30,000V to 40,000V is applied across the tubular electrode 30 and the tube holder 70, and the tubular electrode 30 serves as the anode and the tube holder 70 serves as the cathode or ground electrode. The tubular electrode 30 is in contact with the inner side of the inner quartz tube 50. To increase conductivity between inner quartz tube 50 and the tubular electrode 30, the inner side of the inner quartz tube 50 is plated with a metal coating 40. Due to the high voltage applied across the two quartz tubes 50, 60, a high heat energy, and thus a high temperature, would be produced in the quartz tubes.

It is known that metal coating may not endure high temperature. As shown in the figures, cooling water is supplied via the water inlet 12. Thus, the heat generated in the inner quartz tube 50 can be carried away by the cooling water flowing out of the tube 50 via water outlet 14. The surface of the tube 50 will thus remain at a relatively lower temperature so that the metal coating thereon will not be damaged. The coating can be chosen from a variety of materials regardless of their melting points, and gold, having a lower melting point but good conductivity and a good corrosion-resistant property, is preferred in this condition.

Since the aluminum tube 10 should be kept from direct contact with the cooling water therein, an anodic treatment on the surface of the aluminum tube 10 is preferable.

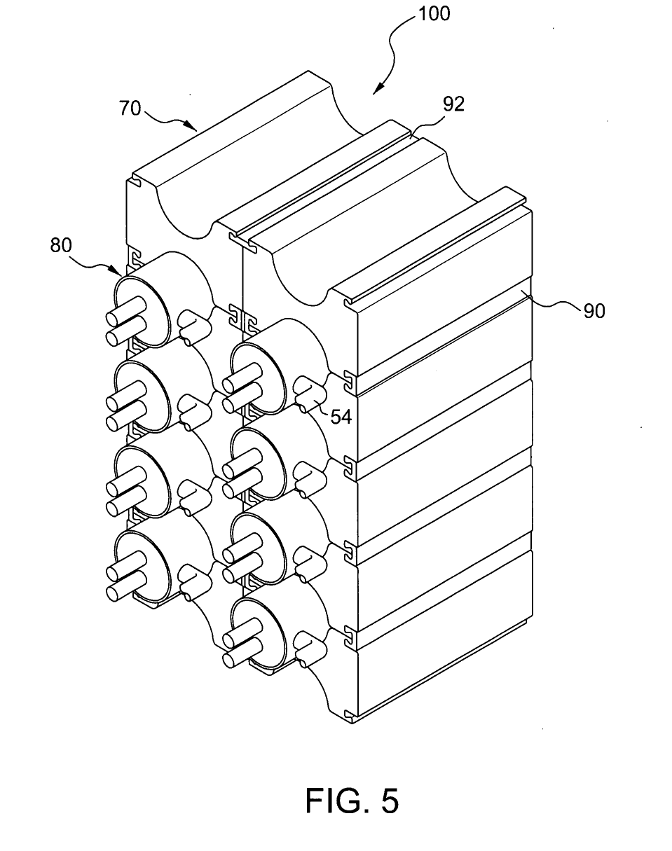

In a preferred embodiment, the tube holder 70, as shown in the figures, is composed of two halves 70′, 70″. The tube holders 70 are configured so that they can be easily connected to each other. Multiple tube modules are necessary in order to produce large amount of ozone. FIG. 5 shows the state in which the tube modules fitted in the tube holders are stacked. With multiple tube modules being operated simultaneously, the capacity to generate ozone can be raised.

For the purpose of easy assembling, the tube holder 70 can be formed by two halves 70′, 70″. For economic purposes, the two halves 70′, 70″ can be made identical.

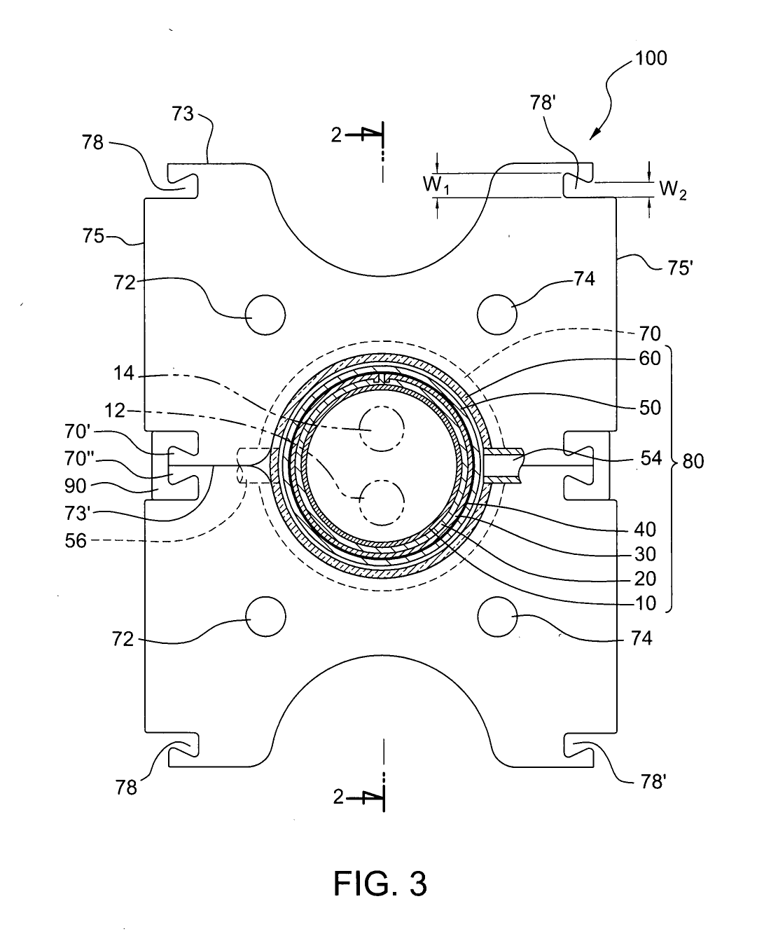

As shown in FIG. 3, the tube holders 70′ and 70″ each comprise a water inlet 72 and a water outlet 74. The tube holder 70 is arranged so that it is in direct contact with the tube module 80, to be more specific, the external surface of the outer quartz tube 60. The side of the tube 70, which contacts the tube module 80, is preferably made into a cylindrical surface so as to better fit with the surface of the tube module 80. Similar to the manner in which the heat generated in the inner quartz tube 50 is carried away by the cooling water passing therein, the heat generated in the outer quartz tube 60 is transferred to the tube holder 70 and carried away by the cooling water passing through the tube holder 70.

As shown in FIGS. 1 and 3, a preferred embodiment of one half of the tube holder 70 has an upper and a lower horizontal surface 73, 73′, a left and a right vertical surface 75, 75′, and thus forms four corners. Two semi-cylindrical surfaces 76 are symmetrically formed on the upper horizontal surface 73 and the lower horizontal surface 73′. A first pair of channels 78 is formed symmetrically on the left vertical surface 75 near the upper left corner and the lower left corner, respectively. A second pair of channels 78′ is formed symmetrically on the right vertical surface 75′ near the upper right corner and the lower right corner, respectively. The second pair of channels 78′ is symmetrical with the first pair of channels 78. Referring to FIG. 3, each of the channels has an inward width W₁ and an outward width W₂, and the inward width W₁ is greater than the outward width W₂.

As shown in FIGS. 1 and 5, a vertical clamp 90 is made to fit the channels formed by the lower channel and the upper channel of two vertically adjacent tube holder halves 70′, 70″ and is used to connect tube holder halves 70′, 70″ together.

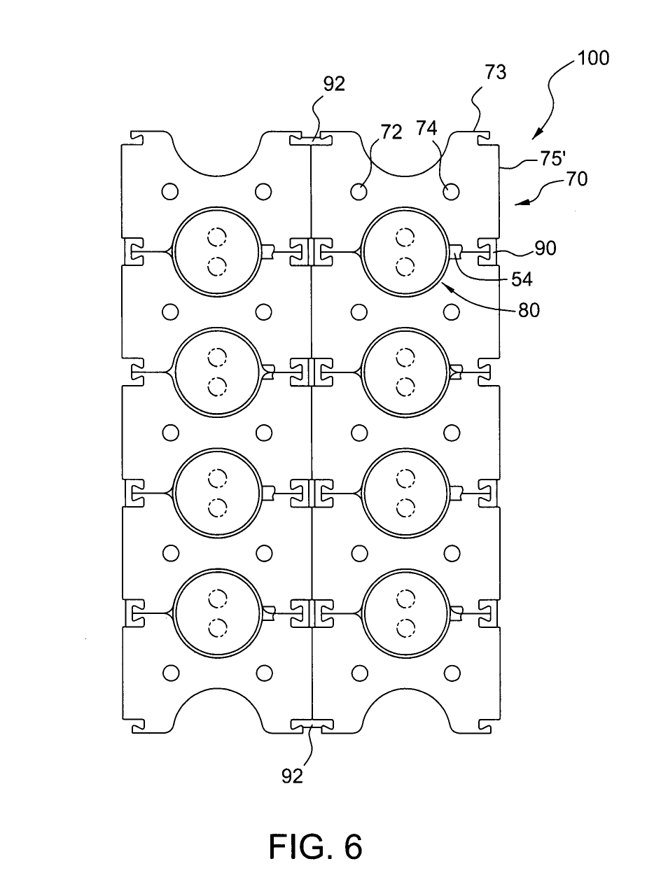

FIG. 5 shows a plurality of tube holder halves connected together with tube modules 80 contained therein. In FIGS. 5 and 6, the tube holders stacked in a vertical manner are connected by vertical clamps 90 and form two separate stacks. The two stacks of tube holders are further connected by a horizontal clamp 92 on the top of the stacks and another one on the bottom of the stacks. The horizontal clamp 92 is made to fit the channels formed by the uppermost two horizontally adjacent tube holders. Another horizontal clamp 92 fits the channels formed by the lower channels of the lowest two horizontally adjacent tube holders.

The preferred material selected to make the tube holder 70 is aluminum since the cost of aluminum is low, and aluminum has a good heat-transfer property and electrical conductivity. In addition, aluminum can be easily formed into the desired shape by extrusion processes, and the material wasted in machining can be avoided.

The invention may also be implemented in other specific modes without departing from the spirit of the invention. Thus, the above-mentioned embodiments shall be regarded as explanatory but not restrictive. All changes that are consistent with the meaning and range of the claims and the equivalents shall fall within the scope claimed by the invention.

1. A twin-tube type ozone generation tube module, comprising:
an aluminum tube having a water inlet and a water outlet therein;
a tubular electrode enclosing the aluminum tube;
an insulation layer filled in between the aluminum tube and the tubular electrode;
an inner quartz tube enclosing the tubular electrode and plated with a metal coating on the internal surface thereof; and
an outer quartz tube enclosing the inner quartz tube and leaving an annular space therebetween, both ends of the annular space being closed, and a gas inlet being provided at one end of the outer quartz tube and a gas outlet being provided at the other end of the outer quartz tube.

2. The module of claim 1, wherein the material used for the metal coating is gold.

3. The module of claim 2, wherein the aluminum tube is anodized on the external surface thereof.

4. A water-cooling ozone generation tube assembly, comprising:
the twin-tube type ozone generation tube module of claim 3; and
a tube holder having at least one water inlet and at least one water outlet therein and enclosing the ozone generation tube module.

5. The assembly of claim 4, wherein the tube holder is formed by two identical halves.

6. The assembly of claim 5, wherein each half of the tube holder has a water inlet and a water outlet.

7. The assembly of claim 6, wherein each half of the tube holder has a semi-cylindrical external surface for fitting to the external surface of the ozone generation tube module.

8. The assembly of claim 7 further comprises a plurality of the ozone generation tube modules and an equal number of one half of the tube holders connected vertically and/or horizontally by clamping means.

9. The assembly of claim 8, wherein one half of the tube holder comprises:
an upper and a lower horizontal surface and a left and a right vertical surface forming four corners, two semi-cylindrical surfaces symmetrically formed on the upper horizontal surface and the lower horizontal surface, a first pair of channels formed symmetrically on the left vertical surface near the upper left corner and the lower left corner, respectively, a second pair of channels formed symmetrically on the right vertical surface near the upper right corner and the lower right corner, respectively, the second pair of channels being symmetrical with the first pair of channels, each of the channels having an inward width and an outward width, and the inward width being greater than the outward width.

10. The assembly of claim 9, wherein the clamping means comprises:
a plurality of vertical clamps, each of which is made to fit to the channels formed by the lower channel and the upper channel of two vertically adjacent tube holders; and
two horizontal clamps, one of which is made to fit the channels formed by the upper channels of the uppermost two horizontally adjacent tube holders, with the other horizontal clamp made to fit the channels formed by the lower channels of the lowest two horizontally adjacent tube holders.

11. The assembly of claim 10, wherein the insulation layer is made of rubber.
